(19) United States
(12) Patent Application Publication
(10) Pub. No.: US 2006/0204675 A1
(43) Pub. Date: Sep. 14, 2006

(54) Display device with improved flexibility

(75) Inventors: Zhanjun Gao, Rochester, NY (US); Richard D. Bomba, Rochester, NY (US)

Correspondence Address: Paul A. Leipold;Eastman Kodak Company, Patent Legal Staff, 343 State Street, Rochester, NY, 14650-2201, US

(73) Assignee: Eastman Kodak Company

(21) Appl. No.: 11/075,320

(22) Filed: Mar. 8, 2005

(51) Int. Cl. C09K 19/00

(52) U.S. Cl. 428/1.1; 428/1.6

(57) ABSTRACT

The present invention relates to a support for an electrically modulated imaging element and a display made with the support comprising a flexible substrate of nonhomogeneous material and of uniform thickness, which has a less flexible area underlying and more flexible area. The present invention also relates to a support for an electrically modulated imaging element and a display made with the support comprising a continuous flexible layer having attached thereto at least one reinforcing area, wherein the reinforcing area underlies an electrically modulated imaging area. The present invention also includes a method and a coextrusion die apparatus for making the support.

### FIELD OF THE INVENTION

This invention relates in general to a display device, and more particularly to a display device comprising a stiffer support in the pixel areas to limit deformation and related failure, with less stiffness between the pixel areas to allow bending.

### BACKGROUND OF THE INVENTION

Most of commercial displays devices, for example, liquid crystal displays, are rigid. They comprise two plane substrates, commonly fabricated by a rigid glass material, and a layer of a liquid crystal material or other imaging layer, and arranged in-between said substrates. The glass substrates are separated from each other by equally sized spacers being positioned between the substrates, thereby creating a more or less uniform gap between the substrates. Further, electrode means for creating an electric field over the liquid crystal material are provided and the substrate assembly is then placed between crossed polarizers to create a display. Thereby, optical changes in the liquid crystal display may be created by applying a voltage to the electrode means, whereby the optical properties of the liquid crystal material disposed between the electrodes is alterable.

In recent years, scientists and engineers have been enticed by the vision of flexible displays. A flexible display is defined in this disclosure as a flat-panel display using thin, flexible substrate, which can be bent to a radius of curvature of a few centimeters or less without loss of functionality. Flexible displays are considered to be more attractive than conventional rigid displays. They allow more freedom in design and promise smaller and more rugged devices. Under bending moments, the rigid display tends to lose its image over a large area, due to the fact that the gap between the substrates changes, thereby causing the liquid crystal material to flow away from the bending area, resulting in a changed crystal layer thickness. Consequently, displays utilizing glass substrates are less suitable, when a more flexible or even bendable display is desired.

Another advantage of using flexible substrates is that a plurality of display devices can be manufactured simultaneously by means of continuous web processing such as, for example, reel-to-reel processing. The manufacture of one or more display devices by laminating large substrates is alternatively possible. Dependent on the width of the reels used and the length and width of a reel of substrate material, a great many separate display cells or, in the case of “plastic electronics,” separate semi-products can be made in these processes. Such processes are therefore very attractive for bulk manufacture of the display devices and semi-products.

Some efforts have been made in the field of exchanging the above described glass substrates with substrates of a less fragile material, such as plastic. Plastic substrates provide lighter and less fragile displays. One display using plastic substrates is described in the patent document U.S. Pat. No. 5,399,390. However, the natural flexibility of the plastic substrate presents problems, when trying to manufacture liquid crystal displays in a traditional manner. For example, the spacing between the substrates must be carefully monitored in order to provide a display with good picture reproduction. An aim in the production of prior art displays utilizing plastic substrate has therefore been to make the construction as rigid as possible, more or less imitating glass substrates. Thereby the flexible properties of the substrates have not been utilized to the full extent.

U.S. Pat. No. 6,710,841 discloses a liquid crystal display device having a first and a second substrate, being manufactured in a flexible material with a liquid crystal material is disposed between the substrates. Together, the substrates form an array of cell enclosures, each containing an amount of liquid crystal. Further, each of the cell enclosures is separated from the adjacent enclosures by intermediate flexible parts. By creating a display from a flexible material and subdividing the display into a plurality of separate cell enclosures, a flexible, bendable display is produced, which will cause a bending along an intermediate part rather than through a liquid crystal filled cell, thereby maintaining the display quality, since the cells or “pixels” of the display are left intact. U.S. Pat. No. 6,710,841 only applies to displays for which the display module is stiff and therefore, has a high bending stiffness in comparison with the substrate. However, as disclosed in EP 1403687 A2, some displays have nano-dimension conductive layers and display layers. For such displays, the intermediate part has a similar bending stiffness in comparison with the liquid crystal enclosures. Therefore, the enclosures experience bending similar to the intermediate part. The flexibility of the display is limited by the bending limitation of the display enclosures. EP 1403687 A2 also calls for two substrates that sandwich the display enclosures in the middle.

WO 02/067329 discloses a flexible display device comprising a flexible substrate, a number of display pixels arranged in rows and columns on the surface of the substrate, a number of grooves in the surface of the substrate, each of which is formed in between adjacent two rows or columns of the display pixels, and connection lines for electrically interconnecting the plurality of display pixels, thereby providing flexibility to the display device and, at the same time, minimizing the propagation of mechanical stress caused when the display device is bent or rolled. A method of manufacturing the display device is also disclosed. However, the introduction of grooves to the substrate causes significant stress concentration in the grooves. This may lead to substrate fracture during manufacturing or usage.

### PROBLEM TO BE SOLVED

There remains a need for more flexible display devices.

### SUMMARY OF THE INVENTION

The present invention relates to a support for an electrically modulated imaging element comprising a flexible substrate of nonhomogeneous material and of uniform thickness, the flexible substrate having a more flexible area and a less flexible area, wherein the less flexible area underlies an electrically modulated imaging area of the electrically modulated imaging element and a support comprising a continuous flexible layer having attached thereto at least one reinforcing area, wherein the reinforcing area underlies an electrically modulated imaging area. The present invention also relates to a display comprising an array of cell enclosures, wherein the cell enclosures comprise an electrically modulated imaging layer, and a first transparent conductive layer applied to a support, wherein the support comprises a flexible substrate of nonhomogeneous material and of uniform thickness having a more flexible area and a less flexible area, wherein the less flexible area underlies said cell enclosure and a display comprising an array of cell enclosures, wherein the cell enclosures comprise an electrically modulated imaging layer, and a first transparent conductive layer applied to a support, wherein the support comprises a continuous flexible layer having attached thereto at least one reinforcing area, wherein the reinforcing area underlies said cell enclosure. The present invention also includes a method for making a flexible substrate of nonhomogeneous material and of uniform thickness comprising providing at least a first molten polymer stream and at least a second molten polymer stream; combining said first molten polymer stream and said second molten polymer stream into a melt curtain, wherein said first molten polymer stream and said second molten polymer stream are adjacent to each other and oriented vertically; contacting said melt curtain to a cooling roller; elongating said melt curtain; cooling said melt curtain on a chill roller; and stripping said cooled melt curtain off said chill roller and a coextrusion die apparatus for forming a multi-segment sheet comprising extrusion equipment for supplying at least two molten polymers of differing viscosities connected to a die manifold, wherein the die manifold comprises at least two die blocks, one die block for each of the at least two molten polymers, wherein the die block comprises a polymer inlet port for receiving molten polymer, a polymer distribution cavity connecting the polymer inlet port to a pixel slot flow channel, wherein the pixel slot flow channel is connected to an exit slot, and a substrate for receiving the at least two molten polymers from the exit slot.

### ADVANTAGEOUS EFFECT OF THE INVENTION

The present invention includes several advantages, not all of which are incorporated in a single embodiment. The flexible support ensures the integrity and ease of manufacturing of the pixels by producing a stiffer substrate, while the less stiff sections allow significant bending so that the whole display can be curved into a desired form without damage to the liquid crystal. By incorporating a substrate with different materials, the present invention allows much improved flexibility. The display can be bent into a small radius without being rendered inoperable.

### BRIEF DESCRIPTION OF THE DRAWINGS

FIG. 1 represents a section view of one embodiment of the present invention.

FIG. 2 represents a planar view of one embodiment of the present invention.

FIG. 3 represents a cross-sectional view of an embodiment of the present invention as it is being bent. Bending of the flexible display—while the pixel area remains flat, the curvature is achieved by the bending of the low stiffness portion of the support.

FIG. 4 is a schematic of beam bending.

FIG. 5 represents the different curvatures of the different support areas. Bending of the flexible display—while the pixel area remains flat, the curvature is achieved by the bending of the intermediate area that consist of a low stiffness substrate.

FIG. 6 represents another embodiment of the present invention.

FIG. 7 represents a preferred embodiment of a display module.

FIG. 8 illustrates the appearance of a multi-segment coextrusion apparatus suitable for manufacturing of the present invention.

FIG. 9 illustrates a sectional view taken along line 2-2 of FIG. 8.

FIG. 10 is a planar view of another embodiment of the present invention.

FIG. 11 represents a cross sectional view of a flexible support die for use with the present invention.

FIG. 12 shows an extrusion of flexible support for use with the present invention.

FIG. 13 is a planar view showing the internal flow passages of the flexible support die for use with the present invention.

FIG. 14 is graphic showing stress distribution and deflection from finite element analysis of a laminated flexible support.

FIG. 15 is a graphic showing the stress distribution and deflection from a finite element analysis of a solid structure flexible support of the prior art.

FIG. 16 is a planar view of a continuous flexible support with flex beam regions.

FIG. 17 is a schematic of a gravure coating and laminating machine for use with the present invention.

### DETAILED DESCRIPTION OF THE INVENTION

A flexible display according to the present invention should be rugged enough so that it is resistant to several types of mechanical bending and stress during manufacturing and usage. For instance, the flexible display should be capable of withstanding bending during manufacturing when the display pass through small roller or wounded up in roller with small diameters. The flexible displays should remain operational when folded into a curve shape.

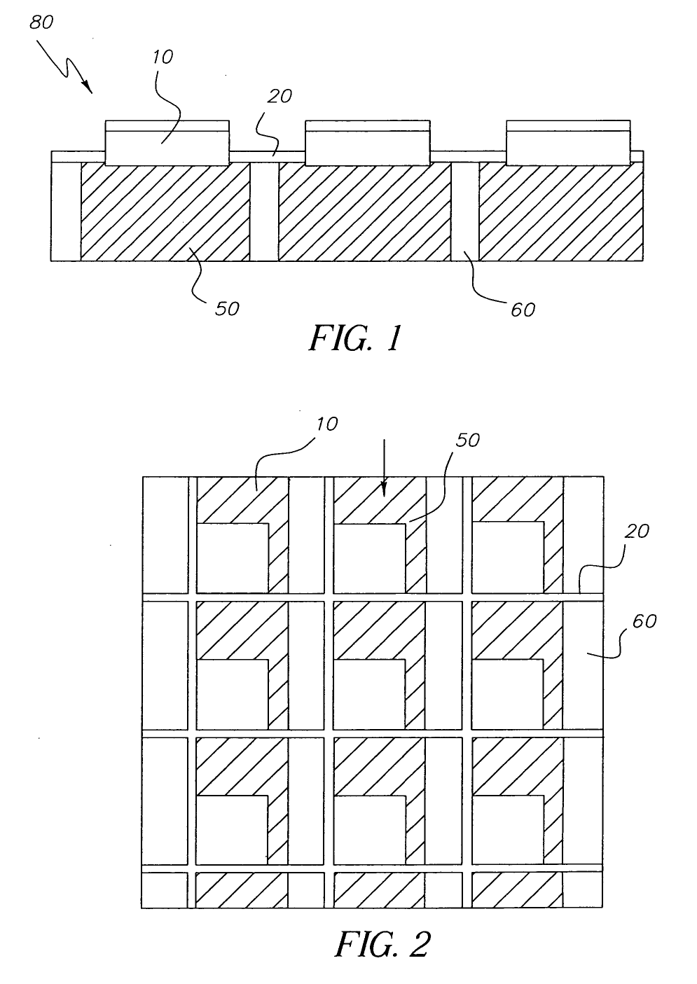

FIG. 1 illustrates one embodiment of this invention, which comprises a support comprising a flexible, non-homogeneous substrate of uniform thickness having a less flexible area and a more flexible area, wherein the less flexible area underlies an electrically modulated imaging area. The stiffer/rigid support area 50 ensures the integrity and ease of manufacturing of the pixels, which are the areas with light-emitting material, such as LCD, OLED, while the flexible/less-stiffer support area 60 allows significant bending so that the support and any layers coated thereon can be curved into a desired form without being damaged. For purposes of the present invention, the term “pixel” is meant to describe the smallest discrete component of an image or picture, usually a colored dot. A pixel (a contraction of picture element) is one of the many tiny dots that make up the representation of a picture. Usually the dots are so small and so numerous that, when printed or displayed, they appear to merge into a smooth image.

In a preferred embodiment, the support is used as the substrate in a flexible display device having a stiff/rigid support area 50 in the pixel areas and flexible/less-stiffer support area 60 between the pixel areas. Display module 10 in FIGS. 1 and 7 is a display element, such as a cholesteric liquid crystal display, disclosed in U.S. Pat. No. 5,695,682, incorporated herein by reference, which may also include conductive layers. A notable example is an organic or polymer light-emitting display (OLEDs or PLEDs). Connecting line 20, usually on both sides of the display module 10, is utilized to address the light-modulating materials in each pixel.

FIG. 1 is a planar view of the present invention. To turn on a pixel, the integrated circuit sends a charge down the correct column of one connecting line 20 and a ground is activated on the connecting line 20 in the correct row of the other. The row and column intersect at the designated pixel, and that delivers the voltage, in the case of LCDs, to untwist the liquid crystals at that pixel.

FIG. 2 is a planar view of an alternative embodiment where the high stiffness support exists in the form of strips. One advantage of this embodiment is that it allows the use of slotted dies that may co-extrude both high stiffness support area 50 and low stiffness support area 60 together to form the support for the flexible display. Such a display, when bent along the direction of the strips, exhibits much improved flexibility since bending deformation occurs primarily in the low stiffness support area 60.

The advantages of the present invention can be explained using the theory of beam or plate bending as outlined below. When a beam is subjected to a bending moment M, it changes into a curved shape, as illustrated in FIG. 4. In general, the curvature due to a given applied bending moment is related to the Young's modulus (E) and moment of inertia (I) of the beam. More specifically, the radius of curvature is proportional to the applied moment and inversely proportional to the products of E and I.

$$\frac{1}{ρ} = \frac{M}{EI} \qquad ( 1 )$$

For flat sheets, we have

$$I = \frac{{h}^{3}}{12} b \qquad ( 2 )$$

where h is the thickness and b is the width of the sheet. Equation (1) is then written as

$$\frac{1}{ρ} = \frac{12 M}{{Eh}^{3} b} = ( \frac{12 M}{b} ) ( \frac{1}{{Eh}^{3}} ) \qquad ( 3 )$$

Therefore, the bending radius of curvature is proportional to the Eh³ for the given moment and sheet width.

The normal stress existing in the beam is proportional to the distance of y from the neutral axis, as illustrated in FIG. 4.

$$σ = \frac{M}{I} y \qquad ( 4 )$$

Since Hooke's law holds, and therefore, ε=σ/E, it immediately follows that the strain in the beam is

$$ɛ = \frac{M}{EI} y = \frac{y}{ρ} \qquad ( 5 )$$

Hence, the maximum tensile/compression strain in the beam is

$${ɛ}_{max} = \frac{{y}_{max}}{ρ} \qquad ( 6 )$$

where yₘₐₓ is the distance from the neutral axis to the outer fibers of the beam.

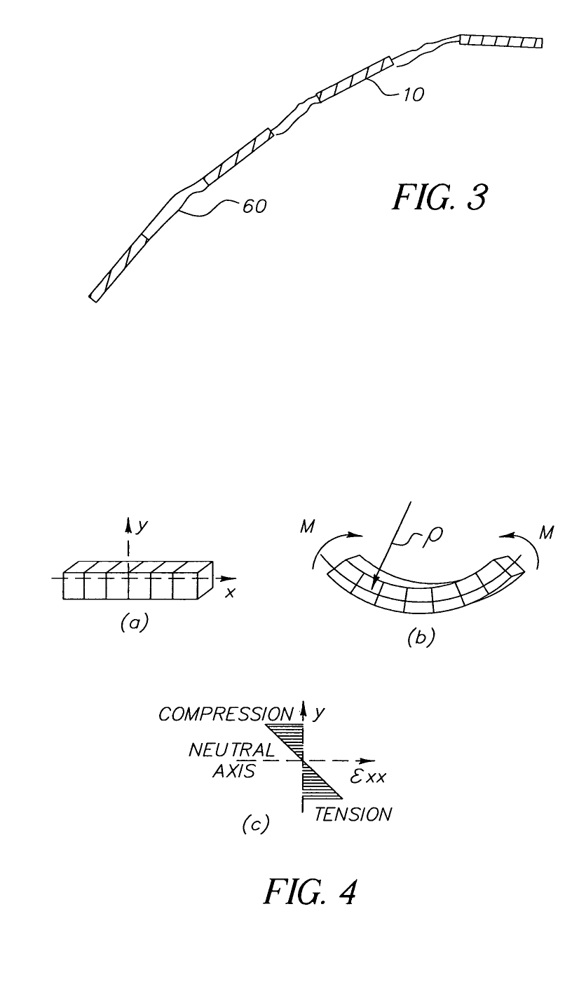

For a given material, the break strength is a material property representing the maximum strain of the material before fracture. Therefore, by increasing the bending curvature (reducing the radius), one can increase the maximum strain in the materials to reach its break strength and cause failure. To prevent failure, one needs to limit the bending curvature below a threshold value. The display module 10 contains conductive layers and other inorganic materials that have low break strength and will fail (fracture) when subjected to a relatively low tensile strain. Referring to FIGS. 3-5, when the display 80 is bent, the display module experiences tensile strain. According to Equation (6), the maximum tensile strain in the display module is proportional to the bending radius of curvature and the distance of the display module to the neutral axis of the display 80. Therefore, to prevent fracture failure, the bending curvature of the display module needs to be limited below a certain level.

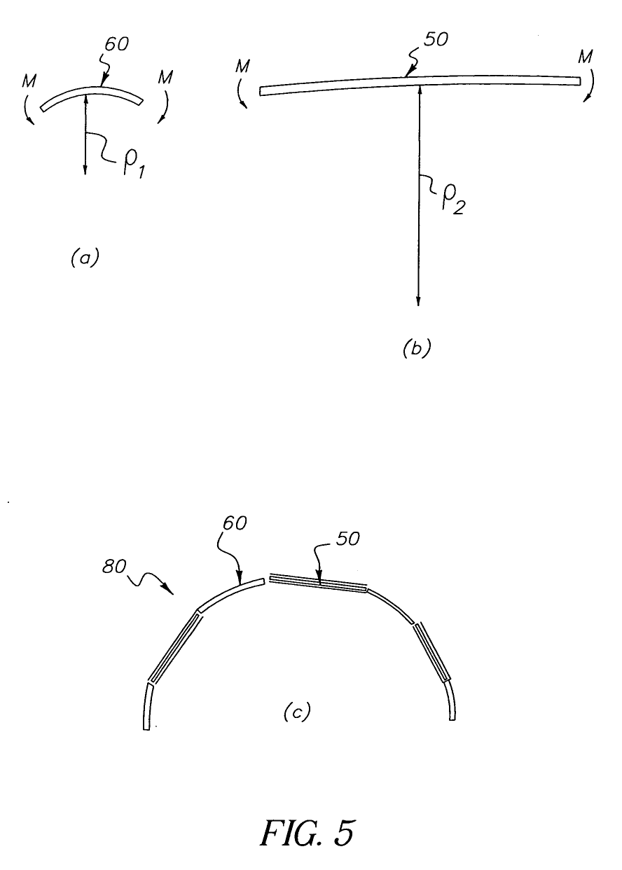

When the display of the present invention is bent, the moment is the same for the sections that contain high stiffness support area 50 and low stiffness support area 60. But support area 50 and support area 60 react differently. As shown in FIGS. 5(a) and 5(b), under the same bending moment, support area 50 develops a much lower curvature in comparison to support area 60. However, as a whole, the display 80 is still able to bend into a small radius, mainly due to the contribution from support area 50.

Let us denote the minimum radii of curvatures, below which the display breaks, for support area 60 (more flexible area) and support area 50 (less flexible area) as ρ₁ and ρ₂ respectively. Parameter ρ₁ represents the minimum radius of curvature for the prior art display with support area 50 alone (without support area 60), while parameter ρ₂ represents the minimum radius of curvature for the present invention display with both support area 50 and support area 60. The bending stiffness ratio η is defined as

$$η = \frac{{ρ}_{2}}{{ρ}_{1}} = ( \frac{{E}_{2}}{{E}_{1}} ) . \qquad ( 7 )$$

This ratio η indicates the improvement of flexibility of the present invention. For instance, if the ratio η is equal to 0.5, it means that the minimum radius of curvature of the display is reduced to 50% of the prior art level. It is easy to see from Equation (7) that the improvement in flexibility can be achieved through change of stiffness.

It is clear from Equation (7) that the ratio of the minimum radius of curvatures of support area 60 (more flexible area) and support 50 (less flexible area) are determined by the ratio of the stiffness (Young's modulus) for support area 50 to support area 60. For instance, if the Young's moduli of the support area 60 and support area 50 are 1.2 GPa (high density polyethylene) and 4.76 GPa (polyethylene terephthalate (PET)), respectively, the less flexible area (support area 50) has a minimum radius of curvature that is 3.97 times of that of the more flexible area (support area 60). The number 3.97 is obtained from the stiffness ratio, 4.76/1.2. The stiffness ratio ranges from 1.5 (for polymer to polymer) to 16 (for metal or composite to polymer). Preferably, the less flexible area has a radius of curvature that is between 1.5 times and 16 times of that of the more flexible area, and most preferably, the less flexible area has a radius of curvature that is between 3 times and 10 times of that of the more flexible area.

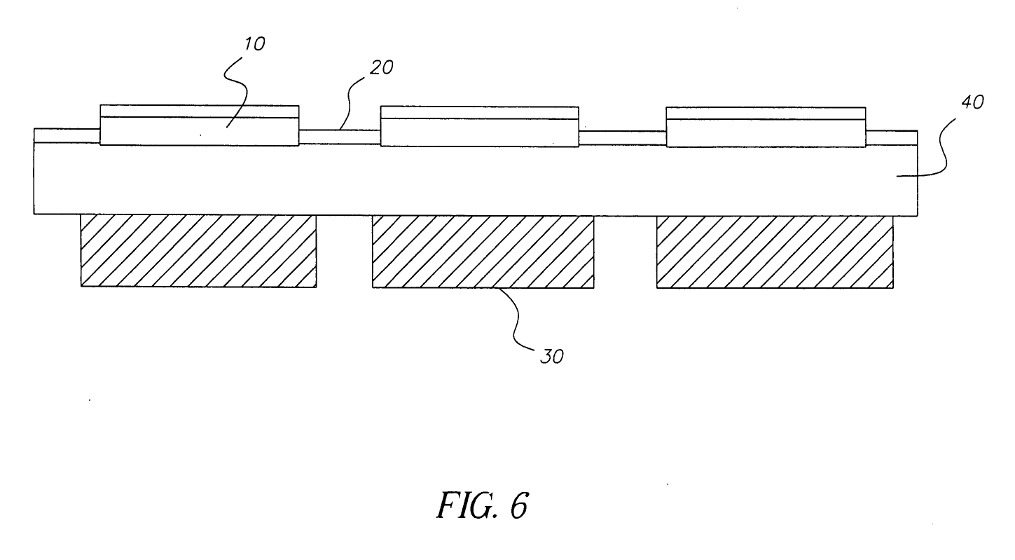

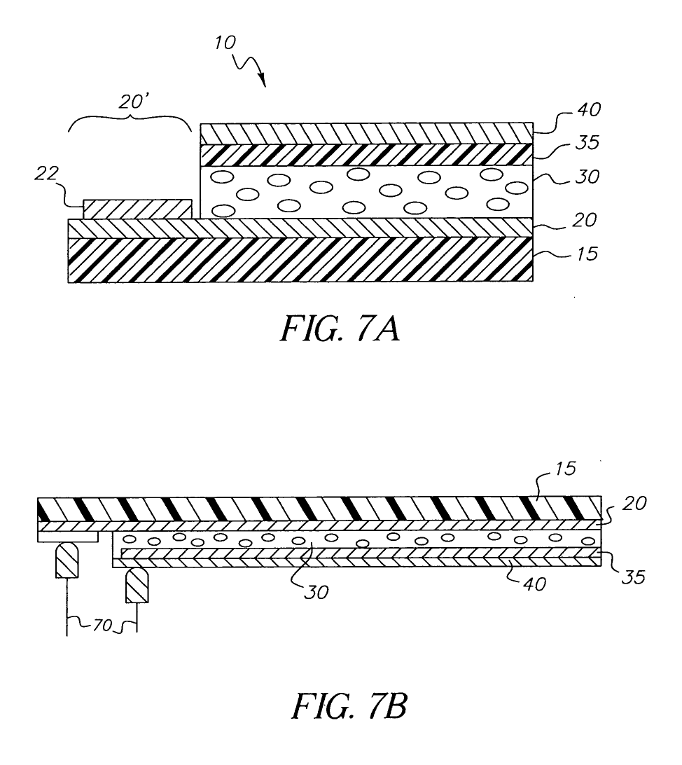

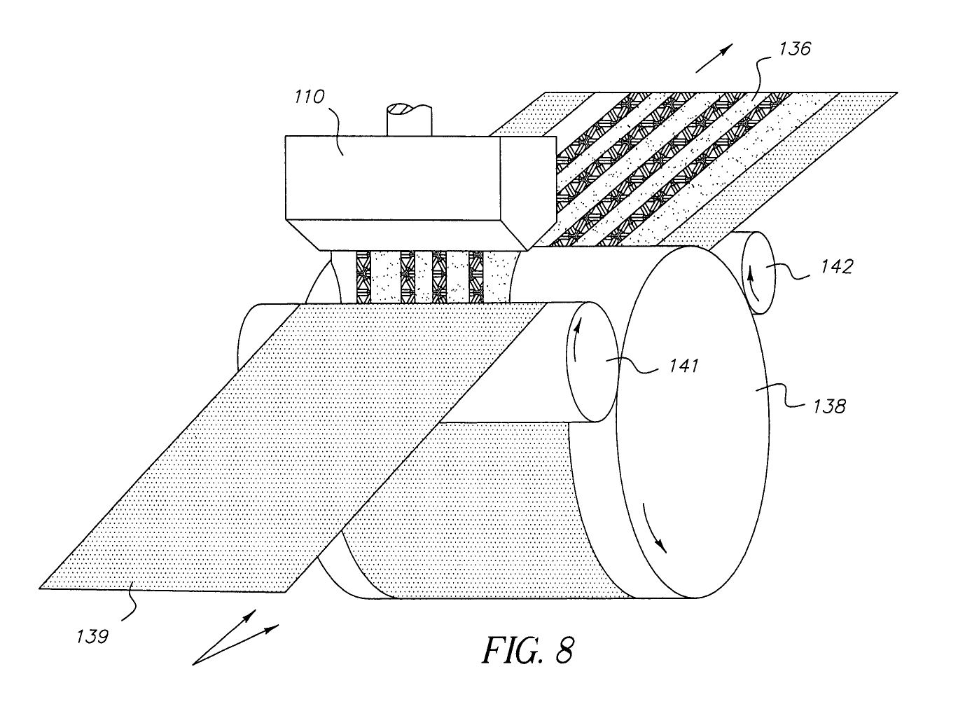

FIG. 6 illustrates an alternative embodiment of the present invention where the low stiffness support area 90 is continuous while the high stiffness support area 70 only covers the pixel areas and may or may not be integral with the low stiffness support area. The high stiffness support area 50 may also exist in the form of strips shown in FIG. 2.

It should be pointed out that U.S. Pat. No. 6,710,841 discloses a liquid crystal display device containing an array of cell enclosures, each containing an amount of liquid crystal. Each of the cell enclosures is separated from the adjacent enclosures by intermediate flexible parts. According to the description in U.S. Pat. No. 6,710,841, in order to achieve the objective of creating a flexible display, the crystal filled cell enclosures need to be relatively rigid in comparison with the substrates so that bending occurs along the intermediate part rather than through a liquid crystal filled cell. In some of the display devices disclosed in U.S. Pat. No. 6,710,841, the display modules consist of thin liquid crystal and conductor layers (for example, 10 microns or less LCD, and 0.1 microns ITO conductive layers). The enclosures have little effect on the bending stiffness of the display substrates. Therefore, the liquid crystal filled cell will experience essentially the same bending curvature as the intermediate part. Furthermore, U.S. Pat. No. 6,710,841 calls for two substrates that sandwich the display enclosures in the middle, unlike the present invention. As a result of the introduction of stiffer areas in the substrate of the present invention, the bending is concentrated in the between-pixel areas regardless of the display enclosure stiffness.

The present invention calls for two types of materials for use in supports, which may be used for support area 50 and support area 60 in the first preferred embodiment shown in FIG. 1 and support 90 and support reinforcement 70 in the second preferred embodiment shown in FIG. 6. The key to the present invention is the bending stiffness ratio η (bending stiffness of the between-pixel area over the bending stiffness of the pixel area). Detail of the definition of a general multilayered plates/beams can be found in “Analysis and Performance of Fiber Composites” (B. D Agarwal and L. J. Broutman, 2nd Edition, John Wiley & Sons, Inc., New York, 1990). In general, the bending stiffness is an increasing function of Young's modulus and thickness of the material. For the first preferred embodiment in FIG. 1, the bending stiffness ratio is equal to the Young's modulus ratios of the support materials in area 60 and area 50, according to Eqn. (7), which requires that the support area 50 is stiff, while support area 60 is less stiff. For the second preferred embodiment shown in FIG. 6, the bending stiffness ratio depends on the Young's moduli and thicknesses of support 90 and reinforcement 70. In general, it is preferable that the bending stiffness is less than or equal to 0.5.

The flexible plastic substrate suitable for support areas 50 and area 60 (area 70 and 90 for the second preferred embodiment) can be thin metal material (such as aluminum foil), flexible plastic film or combination of them. “Plastic” means a high polymer, usually made from polymeric synthetic resins, which may be combined with other ingredients, such as curatives, fillers, reinforcing agents, colorants, and plasticizers. Plastic includes thermoplastic materials and thermosetting materials.

The flexible plastic film must have sufficient thickness and mechanical integrity so as to be self-supporting, yet should not be so thick as to be rigid. Typically, the flexible plastic substrate is the thickest layer of the composite film. Consequently, the substrate determines to a large extent the mechanical and thermal stability of the fully structured composite film.

Another significant characteristic of the flexible plastic substrate material is its glass transition temperature (Tg). Tg is defined as the glass transition temperature at which plastic material will change from the glassy state to the rubbery state. Tg may comprise a range before the material may actually flow. Suitable materials for the flexible plastic substrate include thermoplastics of a relatively low glass transition temperature, for example up to 150° C., as well as materials of a higher glass transition temperature, for example, above 150° C. The choice of material for the flexible plastic substrate may depend on factors including manufacturing process conditions, such as deposition temperature, and annealing temperature, as well as post-manufacturing conditions such as those found in a process line of a display manufacturer. Certain of the plastic substrates discussed below can withstand higher processing temperatures of up to at least 200° C., some up to 300-350° C., without damage.

Typically, the flexible plastic substrate is polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, cellulose acetate butyrate, aliphatic polyurethanes, polyacrylonitrile, polytetrafluoroethylenes, polyvinylidene fluorides, poly(methyl(x-methacrylates), an aliphatic or cyclic polyolefin, polyarylate (PAR), polyetherimide (PEI), polyethersulphone (PES), polyimide (PI), Teflon poly(perfluoro-alboxy)fluoropolymer (PFA), poly(ether ether ketone) (PEEK), poly(ether ketone) (PEK), poly(ethylene tetrafluoroethylene)fluoropolymer (PETFE), and poly(methyl methacrylate) and various acrylate/methacrylate copolymers (PMMA). Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic substrate is a cyclic polyolefin or a polyester. Various cyclic polyolefins are suitable for the flexible plastic substrate. Examples include Arton® made by Japan Synthetic Rubber Co., Tokyo, Japan; Zeanor T made by Zeon Chemicals L.P., Tokyo Japan; and Topas® made by Celanese A. G., Kronberg Germany. Arton is a poly(bis(cyclopentadiene)) condensate that is a film of a polymer. Alternatively, the flexible plastic substrate can be a polyester. A preferred polyester is an aromatic polyester such as Arylite. Although various examples of plastic substrates are set forth above, it should be appreciated that the areas of the substrate can also be formed from other materials such as fibers, for example, glass or quartz fibers, and fillers, for example, carbon, graphite and inorganic particles.

In a preferred embodiment, the less flexible area is preferably flexible metal, metal foil, polyethylene terephthalate (PET), polyethylene naphthalate (PEN), polyethersulfone (PES), polycarbonate (PC), polysulfone, phenolic resin, epoxy resin, polyester, polyimide, polyetherester, polyetheramide, and poly(methyl methacrylate). The more flexible area is preferably cellulose acetate butyrate, aliphatic polyurethanes, polyacrylonitrile, polytetrafluoroethylenes, polyvinylidene fluorides, aliphatic or cyclic polyolefin, polyarylate (PAR), polyetherimide (PEI), polyethersulphone (PES), polyimide (PI), Teflon poly(perfluoro-alboxy)fluoropolymer (PFA), poly(ethylene tetrafluoroethylene)fluoropolymer (PETFE), high density polyethylene (HDPE), low density polyethylene (LDPE), polypropylene and oriented polypropylene (OPP).

The flexible plastic substrate can be reinforced with a hard coating. Preferably, the hard coating is an acrylic coating. Such a hard coating may have a thickness of from 1 to 15 microns, preferably from 2 to 4 microns and can be provided by free radical polymerization, initiated either thermally or by ultraviolet radiation, of an appropriate polymerizable material. Depending on the substrate, different hard coatings can be used. When the substrate is polyester or Arton, a particularly preferred hard coating is the coating known as “Lintec.” Lintec contains UV-cured polyester acrylate and colloidal silica. When deposited on Arton, it has a surface composition of 35 atom % C, 45 atom % 0, and 20 atom % Si, excluding hydrogen. Another particularly preferred hard coating is the acrylic coating sold under the trademark “Terrapin” by Tekra Corporation, New Berlin, Wis.

In one embodiment, a sheet supports a conventional polymer dispersed light-modulating material. The sheet includes a substrate. The substrate may be made of a polymeric material, such as Kodak Estar film base formed of polyester plastic, and have a thickness of between 20 and 200 microns. For example, the substrate may be an 80 micron thick sheet of transparent polyester. Other polymers, such as transparent polycarbonate, can also be used. Alternatively, the substrate may be thin, transparent glass.

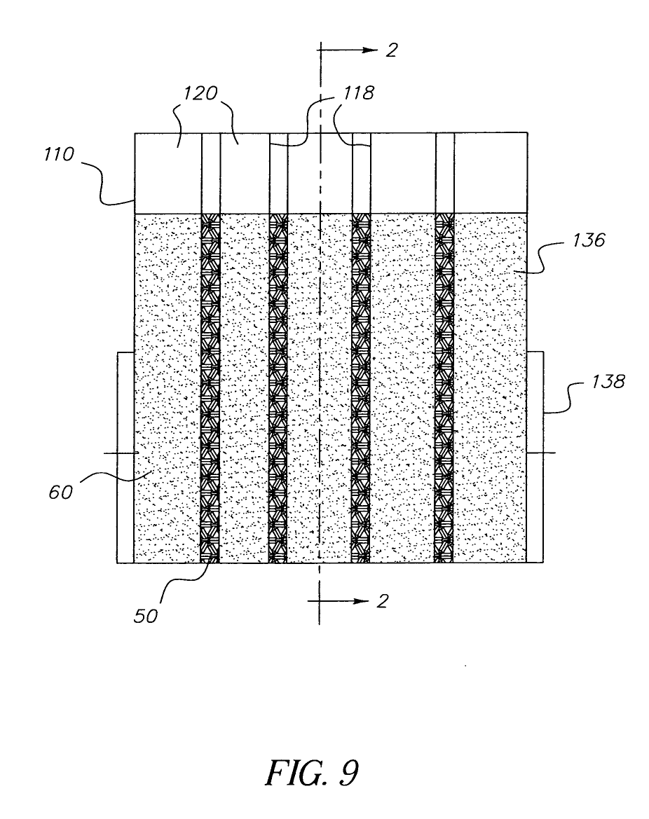

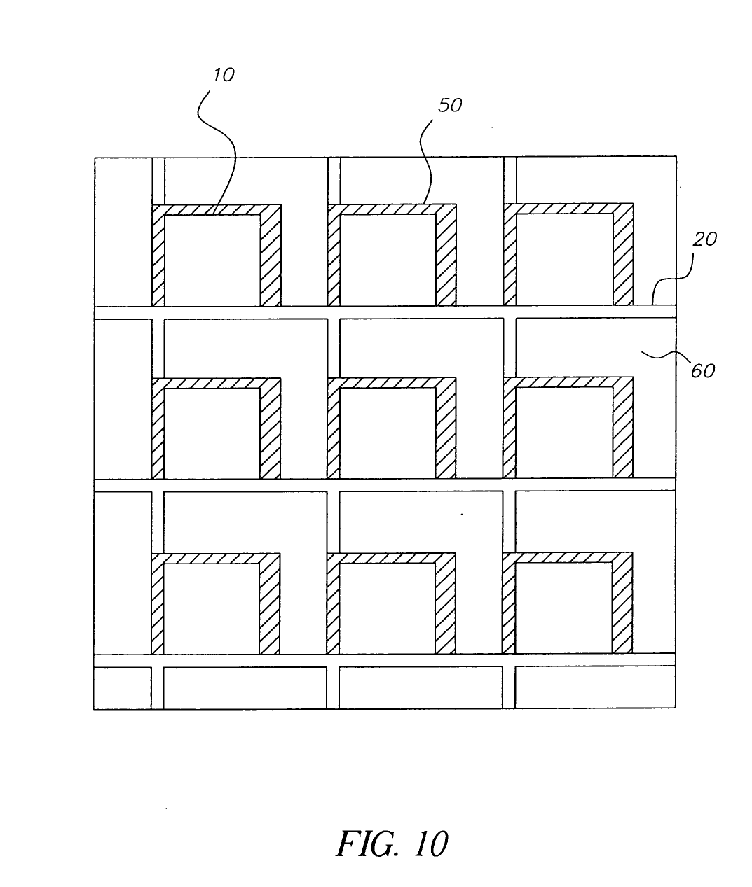

FIG. 8 shows the appearance of a coextrusion apparatus including a multi-segment sheet and flexible support co-extrusion die 200 used to produce the present invention. FIG. 9 is a sectional view taken along a line 2-2 of the flexible support co-extrusion die 200.

As shown in FIG. 8, the flexible support co-extrusion die 200 comprises manifolds 100 and 110 to which respective melted resins for support area 50 and support area 60 are supplied from screw extruders (not shown). A plurality of die blocks are combined to construct the manifolds 118 and 120, the passages and the slot in the flexible support co-extrusion die 200.

When the coextrusion apparatus forms a multi-segment sheet 136 for a display support, the melted resins, which are measurably different in viscosity, are supplied to the manifolds 118 and 120. The viscosities may vary by up to about a factor of 2×. The melted resins are extruded onto a substrate 139, which moves on a cooling roller 138. The substrate 139 is covered with the extruded resin layers between the cooling roller 138 and a nip roller 141, and becomes the sheet 136 with support area 50 and support area 60 in different sections. The sheet 136 separates from the cooling roller 138 via a release roller 142.

Methods of making this new flexible display device may include laser pixel placement, coating or co-extrusion with slotted dies, micro-machining, metal masking and patterning process, and reactive ion etching process.

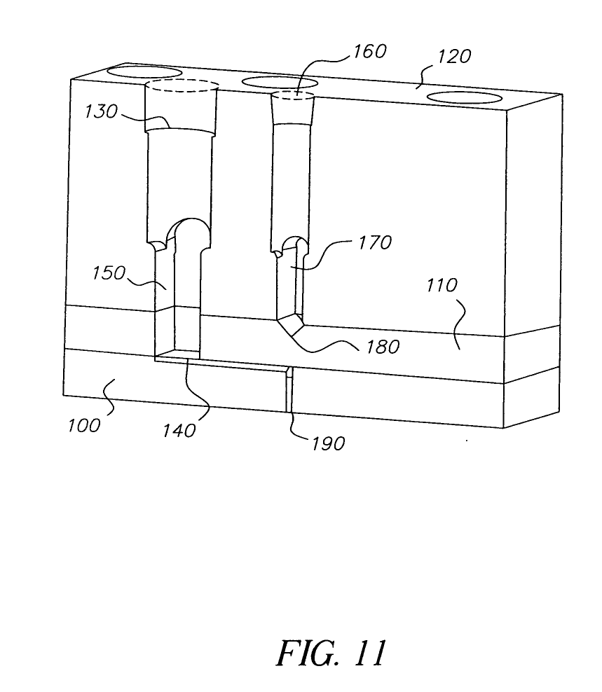

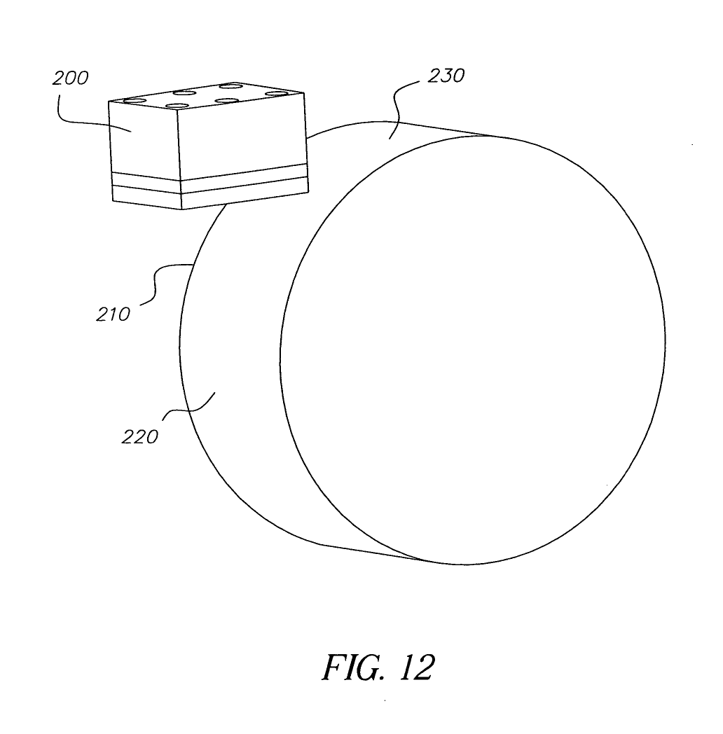

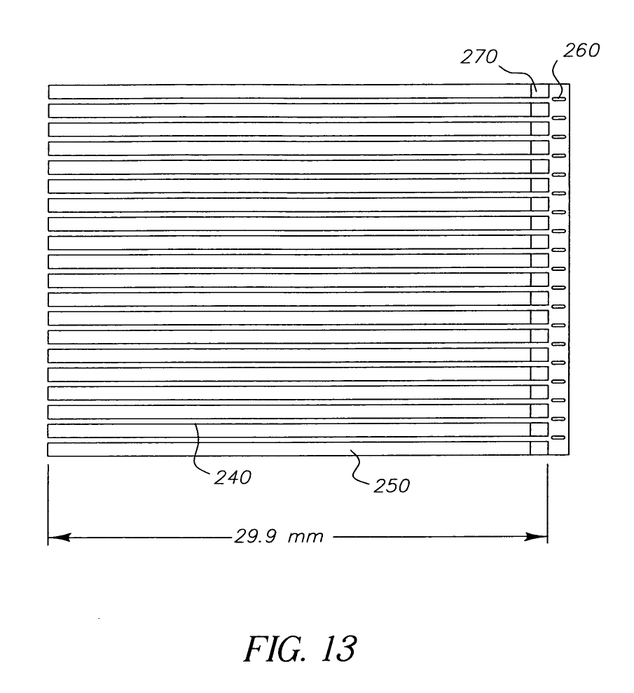

FIG. 11 shows a sectional view of an isometric representation of a flexible support co-extrusion die 200. FIG. 12 represents a manufacturing arrangement consisting of the flexible support co-extrusion die 200, cooling roller 230 and the flexible support in molten state, flexible support melt curtain 210, and flexible support in web format 220. The flexible co-extrusion die 200 represents a design to produce a flexible support element approximately 20 mm wide by 0.2 mm thick on a continuous basis. Commercially available extrusion equipment is utilized to transform polymer 1 pellets and polymer 2 pellets into pressurized molten supply streams to the polymer inlet ports 130, 160 (FIG. 11). For the purposes of this description, polymer 1 will be associated with the rigid pixel region of the support 50 and polymer 2 will be associated with the flexible region between-pixel region 60. In FIG. 11, polymer 1 enters the polymer 1 inlet port 130 which is part of the die manifold 120 then enters the polymer 1 distribution cavity 150. The molten polymer 1 continues to flow to the pixel slot flow channel 140 which is machined into the pixel slot die element 100. Polymer 2 enters supply (flow) port 160 and flows into the polymer 2 distribution cavity 170 and on to the flex slot flow channel 180. The two polymers combine in a repeating arrangement of polymer 1 and polymer 2 along the exit slot 190. FIG. 13 represents a sectional view taken at the interface of the pixel slot element 100 and the flex slot element 110. The pixel slot flow channel 140 is approximately 30 mm long with a flow area measuring 1 mm tall by 0.8 mm wide. There is a pixel flow chamber dividing wall 240 that is approximately 0.2 mm wide. These channels are formed between the machined regions into the pixel slot die element and the bottom surface of the flex slot die element 110. The flex slot flow channel 260 is approximately 6 mm long with a flow area measuring 1 mm tall by 0.2 mm wide. The exit slot 190 (FIG. 11) is approximately 10 mm long with a flow area of 1 mm tall by 20 mm wide. These measurements exemplify a preferred embodiment. However, it is understood that these measurements may be larger as well as 2-4 times smaller. The two polymers are arranged in a repeating pattern with a pitch of 1 mm consisting of polymer 1 at 0.8 mm wide adjacent to polymer 2 at 0.2 mm. The design of the die elements is structured to provide laminar flow conditions for both polymers. Each melt stream joined at the pixel flow transition region 270 (FIG. 13) at the entrance to exit slot 190 and remains undisturbed as is flows through this region. It is generally known that laminar flow streams will experience little or no mixing. Once the molten polymer array exits the die it is referred to as a melt curtain 210 (FIG. 12). This melt curtain is subject to elongation due to the contact with the cooling roller 230. The acceleration results in an elongation of the melt curtain. Approximately 75% of the melt curtain experiences planar deformation. This simply means that the thickness of the melt curtain is reduced in direct proportion to the draw down ratio as calculated from the cooling roller surface velocity divided by the die exit velocity. Common draw down ratios for use with the present invention vary from 1:1 to 100:1. Typical ranges may be at least 5:1, and preferably at least 10:1. This would result in a final flexible support thickness of 0.1 mm. A lower draw down ratio could be used to make a thicker web. The central region experiences mainly strain in the thickness direction therefore the pixel region and flex region dimensions will only change in thickness. The width and distribution of each will remain as arranged in the die cavity. The dimensions of the uniformly distributed region would be approximately 15 mm wide by 0.1 mm thick, consisting of 15 pixel element regions, each 0.8 mm wide separated by flex element regions 0.2 mm wide. The outer regions of the melt curtain experience multi axis-strain and would most likely be trimmed away before winding the final product. Depending on the polymer physical properties, the delivery temperature ranges from 150 degrees Centigrade to 350 degrees Centigrade. The molten polymer is then cooled on the chill roller and stripped off the surface once the desired bulk temperature has been reached. This design represents a general configuration for a 20 mm wide support element. This design is easily modified to manufacture flexible supports in excess of 1000 mm. The support can be directly formed into a web-like material or be cast onto a carrier web substrate 139 as shown in FIG. 8.

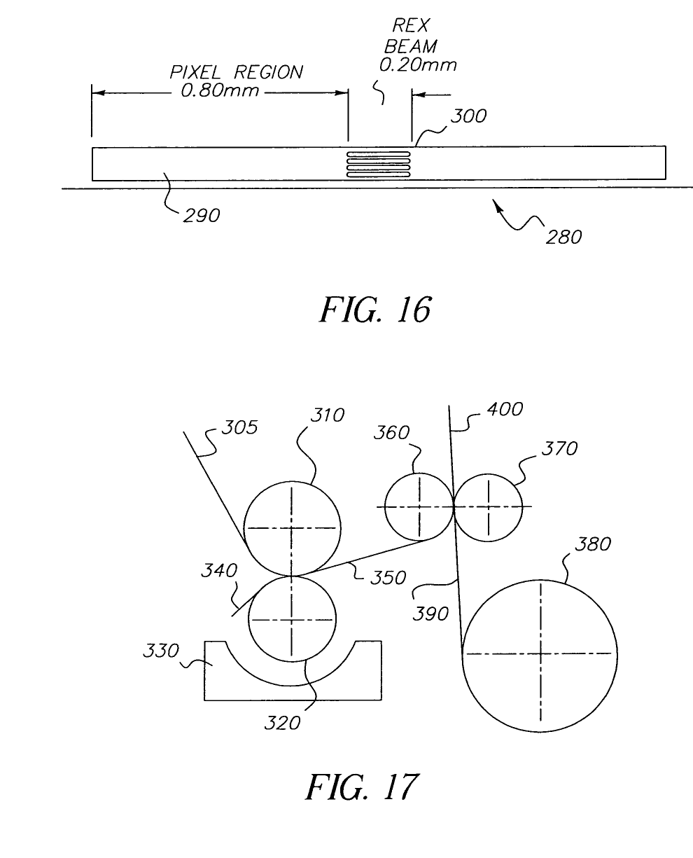

FIG. 16 represents an alternative embodiment of the present invention, laminate support element 280, where flex beam element 300, a region of low flexural stiffness, is arranged in a regular pattern with high stiffness pixel support regions 290. General beam bending analysis is based on material properties as well as geometric stiffness. The geometric stiffness of a component is referred to as the area moment of inertia. An equivalent improvement in support flexibility can be obtained by modifying the moment of inertia of a section.

The following calculations show the effect on bending stiffness due to removing the shear linkage between layers in a laminated structure versus a solid structure. The area moment of inertia of a solid structure is denoted by I_{solid} and is calculated based on the product of the base width, b_{mod}, and the height of the section, h raised to the third power, quantity then divided by the constant 12. This results in a value with length dimension raised to the fourth power. The area moment of inertia of a multiple layer structure is the sum of the area moment of inertia values of each layer calculated separately. Iₗₐₘ denotes this quantity and is calculated again utilizing the same value for base width, b_{mod}, for comparison and the height of the top layer thickness, hₜₒₚ, and a middle layer thickness, h_{midl}, each raised to the third power. The area moment of inertia of the multi-layer structure is based on six layers, a top and bottom layer, each of htop thickness and four middle layers, each of thickness hmidl. The parameter lamda is calculated by dividing the solid area moment of inertia, Isolid, by the laminated structure area moment of inertia, Ilam. The result is a dimensionless parameter that provides an indication of the structural stiffness ratio of a solid structural element as compared to a structural element consisting of non-fused layers. The value of fifty shown indicates that the solid structure is fifty times stiffer than the non-fused layer structure.

$${b}_{mod} := 0.2 mm h = 0.1 mm$$

$${I}_{solid} := \frac{1}{12} \cdot {b}_{mod} \cdot {h}^{3} {I}_{solid} = 4.004 \times {10}^{- 11} {in}^{4}$$

$${h}_{top} := .02 mm {h}_{midl} := 0.01 mm$$

$${I}_{lam} := \frac{1}{12} \cdot {b}_{mod} \cdot ( 2 \cdot {h}_{top}^{3} + 4 \cdot {h}_{midl}^{3} ) {I}_{lam} = 8.008 \times {10}^{- 13} {in}^{4}$$

$$λ := \frac{{I}_{solid}}{{I}_{lam}} λ = 50$$

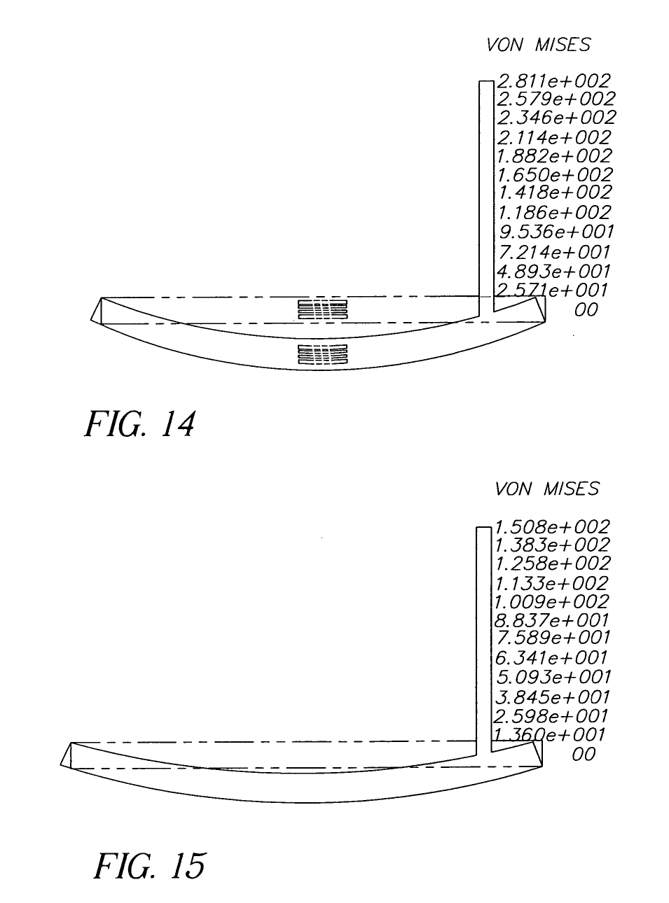

The flex regions are approximately fifty times weaker than adjacent pixel regions. As shown in FIG. 14 and FIG. 15 which are the result of finite element calculations on the proposed structures. FIG. 14 shows the Von Mises stress distribution along with deflection of the structure resulting from a small pressure load applied to the top. The outline represents the undeformed structure. FIG. 15 shows the Von Mises stress distribution along with deflection of the solid structure resulting from an identical pressure load applied to the top of the laminated structure of FIG. 14. The outline represents the undeformed structure in both figures. The laminate structure deflects more than the solid structure for the same applied load and the stress distribution is more localized at the flex region thereby minimizing the effect on the pixel components. Therefore more curvature is possible with the laminate structure than an equivalent thickness solid structure.

This method enables the flex axis to be oriented along the machine directions or perpendicular to the machine direction and if desired to create a network of rigid pixel regions connected between flex regions in both axial directions. Single axis flexibility enables cylindrically shaped flexible support structures. Dual axis flexibility enables spherically shaped flexible support structures. FIG. 17 shows a schematic representation of gravure coating and laminating machine.

The embodiments of the present invention are made by various methods. In one method, the support is made by providing at least a first molten polymer stream and at least a second molten polymer stream, combining the first molten polymer stream and the second molten polymer stream into a melt curtain, contacting said melt curtain to a cooling roller, elongating said melt curtain, cooling said melt curtain on a chill roller; and stripping said cooled melt curtain off said chill roller. In the melt curtain, the polymers are positioned side-by-side in an adjacent manner, having been combined or extruded vertically aligned. Co-extrusion of molten polymer in the prior art typically provides layers oriented horizontally, that is, one on top of another, as opposed to the side-by-side orientation of the present invention.

The flexible support is formed by the lamination of multiple layers of a thin substrate. In the regions requiring higher structural rigidity, the layers would be fused to create a shear force between layers. The adjoining regions of lower structural rigidity would be able to slide over each other upon flexure. The fusing process can be accomplished by many different techniques a few of which have been summarized in the table below:

| Method | Process | Description |
|---|---|---|
| Thermal Fusing | Ultrasonic Horn locally | Commercially |
| | heats pixel region to soften | available |
| | substrate. Pressure applied | equipment |
| | to create bond. | |
| | 1- Nip action between | Commercially |
| | heated, patterned | available |
| | rollers | equipment |
| Adhesive Layer | 1- Gravure coat regular | Commercially |
| | pattern of pressure | available |
| | sensitive adhesive | equipment |
| | patches then laminate | |

An ultrasonic horn is a device which utilizes high frequency vibration to locally heat a substrate. For this application, tooling would be attached to the ultrasonic generating device that would contact the outer surface of a stack of multiple layers of thin substrate and form a pressure point between the contact surface and a support point at the extreme surface of the multiple layer stack. The localized vibration and pressure created at the interface will generate sufficient heat to sufficiently soften the thin substrate layers to form a bond at each interface within the localized elevated temperature and elevated pressure region. A multiple layer stack is formed by unwinding multiple thin substrates from stock rolls, then conveying each web to nip point in which the layers can be arranged on top of each other to form a stacked structure of thin substrate layers. After the nip point, the stack is conveyed toward the ultrasonic fusing station. Downstream tension k pulls the stack through the ultrasonic fusing contact region. The stacked structure exiting the ultrasonic fusing contact region now consists of machine direction fused regions coinciding with the spacing of the ultrasonic tooling. Multiple ultrasonic devices would be arranged across the width of the substrate to form the desired frequency of fused and unfused regions. Ultrasonic fusing devices are commonly used to fuse plastic parts together. The tooling design is dependent on materials to be fused, layer thickness, contact dwell time and contact pressure. Ultrasonic techniques can also be applied in a discrete mode as compared to the continuous web conveyance method described previously. Ultrasonic tooling can be used to create a grid like pattern of fused regions in both the machine direction of the stack and the cross direction of the stack. A step and repeat action of the grid like tooling would be used to generate the desired fused regions while the stack is fixed with respect to the ultrasonic fusing apparatus.

Thermal fusing can be accomplished by the nip action between two rollers. A multiple layer stack is formed by unwinding multiple thin substrates from stock rolls, then conveying each web to nip point in which the layers can be arranged on top of each other to form a stacked structure of thin substrate layers. At least one nip roller would machined to have a series of circumferential rings axially positioned along the roller face. Rings would create a surface of slightly elevated regions with respect to the remaining roller surface. The second roller in the nip would either smooth surfaced or machined to form a mirrored pattern of the first roller. The nip formed by radially loading the two rollers together creates regions of localized higher pressure on the stack material. The higher pressure regions conduct heat readily into the stack to soften each layer and in combination with the pressure provide suitable conditions to fuse each interface of the multiple thin substrate layers. This results in a cross width structure of fused and unfused regions along the machine conveyance direction. Upon exiting the nip point, the web would be conveyed to a winding station to form a wound roller for further processing.

The commercially available gravure coating process is shown schematically in FIG. 16 to implement the adhesive fusion method. Laminate layer 1 305 is conveyed to impression roller 310. The gravure drum (engraved roller) 320 consists of a fine pattern of cells that are filled with adhesive from coating trough 330 and metered by scraper blade 340. This gravure drum is brought into contact with laminate layer. Droplets of adhesive material will be transferred to the laminate surface in a regular pattern. The size and distribution of the droplets is dependent on pixel geometry, flex region geometry, final adhesive thickness, and adhesive material. The adhesive fusing method would be repeated to build a multiple layer stack, in which, each gravure station would add another layer of thin substrate fused in a similar pattern to the previous layer.

The flexible support bears an electrically modulated imaging layer on at least one surface. A suitable material may include electrically modulated material disposed on a suitable support structure, such as on or between one or more electrodes. The term “electrically modulated material” as used herein is intended to include any suitable non-volatile material. Suitable materials for the electrically modulated material are described in U.S. patent application Ser. No. 09/393,553 and U.S. Provisional Patent Application Ser. No. 60/099,888, the contents of both applications are herein incorporated by reference.

The electrically modulated material may also be a printable, conductive ink having an arrangement of particles or microscopic containers or micro capsules. Each micro capsule contains an electrophoretic composition of a fluid, such as a dielectric or emulsion fluid, and a suspension of colored or charged particles or colloidal material. The diameter of the microcapsules typically ranges from 30 to 300 microns. According to one practice, the particles visually contrast with the dielectric fluid. According to another example, the electrically modulated material may include rotatable balls that can rotate to expose a different colored surface area, and which can migrate between a forward viewing position and/or a rear non-viewing position, such as gyricon. Specifically, gyricon is a material comprised of twisting rotating elements contained in liquid-filled spherical cavities and embedded in an elastomer medium. The rotating elements may be made to exhibit changes in optical properties by the imposition of an external electric field. Upon application of an electric field of a given polarity, one segment of a rotating element rotates toward, and is visible by an observer of the display. Application of an electric field of opposite polarity, causes the element to rotate and expose a second, different segment to the observer. A gyricon display maintains a given configuration until an electric field is actively applied to the display assembly. Gyricon particles typically have a diameter of 100 microns. Gyricon materials are disclosed in U.S. Pat. No. 6,147,791, U.S. Pat. No. 4,126,854 and U.S. Pat. No. 6,055,091, the contents of which are herein incorporated by reference.

According to one practice, the microcapsules may be filled with electrically charged white particles in a black or colored dye. Examples of electrically modulated material and methods of fabricating assemblies capable of controlling or effecting the orientation of the ink suitable for use with the present invention are set forth in International Patent Application Publication Number WO 98/41899, International Patent Application Publication Number WO 98/19208, International Patent Application Publication Number WO 98/03896, and International Patent Application Publication Number WO 98/41898, the contents of which are herein incorporated by reference.

The electrically modulated material may also include material disclosed in U.S. Pat. No. 6,025,896, the contents of which are incorporated herein by reference. This material comprises charged particles in a liquid dispersion medium encapsulated in a large number of microcapsules. The charged particles can have different types of color and charge polarity. For example white positively charged particles can be employed along with black negatively charged particles. The described microcapsules are disposed between a pair of electrodes, such that a desired image is formed and displayed by the material by varying the dispersion state of the charged particles. The dispersion state of the charged particles is varied through a controlled electric field applied to the electrically modulated material. According to a preferred embodiment, the particle diameters of the microcapsules are between 5 microns and 200 microns, and the particle diameters of the charged particles are between one-thousandth and one-fifth the size of the particle diameters of the microcapsules.

Further, the electrically modulated material may include a thermo-chromic material. A thermo-chromic material is capable of changing its state alternately between transparent and opaque upon the application of heat. In this manner, a thermo-chromic imaging material develops images through the application of heat at specific pixel locations in order to form an image. The thermo-chromic imaging material retains a particular image until heat is again applied to the material. Since the rewritable material is transparent, UV fluorescent printings, designs and patterns underneath can be seen through.

The electrically modulated material may also include surface stabilized ferrroelectric liquid crystals (SSFLC). Surface stabilized ferroelectric liquid crystals confining ferroelectric liquid crystal material between closely-spaced glass plates to suppress the natural helix configuration of the crystals. The cells switch rapidly between two optically distinct, stable states simply by alternating the sign of an applied electric field.

Magnetic particles suspended in an emulsion comprise an additional imaging material suitable for use with the present invention. Application of a magnetic force alters pixels formed with the magnetic particles in order to create, update or change human and/or machine readable indicia. Those skilled in the art will recognize that a variety of bi-stable non-volatile imaging materials are available and may be implemented in the present invention.

The electrically modulated material may also be configured as a single color, such as black, white or clear, and may be fluorescent, iridescent, bioluminescent, incandescent, ultraviolet, infrared, or may include a wavelength specific radiation absorbing or emitting material. There may be multiple layers of electrically modulated material. Different layers or regions of the electrically modulated material display material may have different properties or colors. Moreover, the characteristics of the various layers may be different from each other. For example, one layer can be used to view or display information in the visible light range, while a second layer responds to or emits ultraviolet light. The non-visible layers may alternatively be constructed of non-electrically modulated material based materials that have the previously listed radiation absorbing or emitting characteristics. The electrically modulated material employed in connection with the present invention preferably has the characteristic that it does not require power to maintain display of indicia.

The preferred electrically modulated imaging layer comprises a liquid crystalline material. Liquid crystals can be nematic (N), chiral nematic (N*), or smectic, depending upon the arrangement of the molecules in the mesophase. Chiral nematic liquid crystal (N*LC) displays are typically reflective, that is, no backlight is needed, and can function without the use of polarizing films or a color filter.

Chiral nematic liquid crystal refers to the type of liquid crystal having finer pitch than that of twisted nematic and super-twisted nematic used in commonly encountered LC devices. Chiral nematic liquid crystals are so named because such liquid crystal formulations are commonly obtained by adding chiral agents to host nematic liquid crystals. Chiral nematic liquid crystals may be used to produce bi-stable or multi-stable displays. These devices have significantly reduced power consumption due to their non-volatile “memory” characteristic. Since such displays do not require a continuous driving circuit to maintain an image, they consume significantly reduced power. Chiral nematic displays are bistable in the absence of a field; the two stable textures are the reflective planar texture and the weakly scattering focal conic texture. In the planar texture, the helical axes of the chiral nematic liquid crystal molecules are substantially perpendicular to the substrate upon which the liquid crystal is disposed. In the focal conic state the helical axes of the liquid crystal molecules are generally randomly oriented. Adjusting the concentration of chiral dopants in the chiral nematic material modulates the pitch length of the mesophase and, thus, the wavelength of radiation reflected. Chiral nematic materials that reflect infrared radiation and ultraviolet have been used for purposes of scientific study. Commercial displays are most often fabricated from chiral nematic materials that reflect visible light. Some known LCD devices include chemically-etched, transparent, conductive layers overlying a glass substrate as described in U.S. Pat. No. 5,667,853, incorporated herein by reference.

In one embodiment, a chiral-nematic liquid crystal composition may be dispersed in a continuous matrix. Such materials are referred to as “polymer-dispersed liquid crystal” materials or “PDLC” materials. Such materials can be made by a variety of methods. For example, Doane et al. (Applied Physics Letters, 48, 269 (1986)) disclose a PDLC comprising approximately 0.4 μm droplets of nematic liquid crystal 5CB in a polymer binder. A phase separation method is used for preparing the PDLC. A solution containing monomer and liquid crystal is filled in a display cell and the material is then polymerized. Upon polymerization the liquid crystal becomes immiscible and nucleates to form droplets. West et al. (Applied Physics Letters 63, 1471 (1993)) disclose a PDLC comprising a chiral nematic mixture in a polymer binder. Once again a phase separation method is used for preparing the PDLC. The liquid-crystal material and polymer (a hydroxy functionalized polymethylmethacrylate) along with a cross-linker for the polymer are dissolved in a common organic solvent toluene and coated on an indium tin oxide (ITO) substrate. A dispersion of the liquid-crystal material in the polymer binder is formed upon evaporation of toluene at high temperature. The phase separation methods of Doane et al. and West et al. require the use of organic solvents that may be objectionable in certain manufacturing environments.

In one embodiment, the liquid crystal may be applied as a substantial monolayer. The term “substantial monolayer” is defined by the Applicants to mean that, in a direction perpendicular to the plane of the display, there is no more than a single layer of domains sandwiched between the electrodes at most points of the display (or the imaging layer), preferably at 75 percent or more of the points (or area) of the display, most preferably at 90 percent or more of the points (or area) of the display. In other words, at most, only a minor portion (preferably less than 10 percent) of the points (or area) of the display has more than a single domain (two or more domains) between the electrodes in a direction perpendicular to the plane of the display, compared to the amount of points (or area) of the display at which there is only a single domain between the electrodes.

The amount of material needed for a monolayer can be accurately determined by calculation based on individual domain size, assuming a fully closed packed arrangement of domains. (In practice, there may be imperfections in which gaps occur and some unevenness due to overlapping droplets or domains.) On this basis, the calculated amount is preferably less than 150 percent of the amount needed for monolayer domain coverage, preferably not more than 125 percent of the amount needed for a monolayer domain coverage, more preferably not more than 110 percent of the amount needed for a monolayer of domains. Furthermore, improved viewing angle and broadband features may be obtained by appropriate choice of differently doped domains based on the geometry of the coated droplet and the Bragg reflection condition.

In a preferred embodiment of the invention, the display device or display sheet has simply a single imaging layer of liquid crystal material along a line perpendicular to the face of the display, preferably a single layer coated on a flexible substrate. Such as structure, as compared to vertically stacked imaging layers each between opposing substrates, is especially advantageous for monochrome shelf labels and the like. Structures having stacked imaging layers, however, are optional for providing additional advantages in some case.

Preferably, the domains are flattened spheres and have on average a thickness substantially less than their length, preferably at least 50% less. More preferably, the domains on average have a thickness (depth) to length ratio of 1:2 to 1:6. The flattening of the domains can be achieved by proper formulation and sufficiently rapid drying of the coating. The domains preferably have an average diameter of 2 to 30 microns. The imaging layer preferably has a thickness of 10 to 150 microns when first coated and 2 to 20 microns when dried.

The flattened domains of liquid crystal material can be defined as having a major axis and a minor axis. In a preferred embodiment of a display or display sheet, the major axis is larger in size than the cell (or imaging layer) thickness for a majority of the domains. Such a dimensional relationship is shown in U.S. Pat. No. 6,061,107, hereby incorporated by reference in its entirety.

Modern chiral nematic liquid crystal materials usually include at least one nematic host combined with a chiral dopant. In general, the nematic liquid crystal phase is composed of one or more mesogenic components combined to provide useful composite properties. Many such materials are available commercially. The nematic component of the chiral nematic liquid crystal mixture may be comprised of any suitable nematic liquid crystal mixture or composition having appropriate liquid crystal characteristics. The nematic liquid crystal phases typically consist of 2 to 20, preferably 2 to 15 components. The above list of materials is not intended to be exhaustive or limiting. The lists disclose a variety of representative materials suitable for use or mixtures, which comprise the active element in electro-optic liquid crystal compositions.

Suitable chiral nematic liquid crystal compositions preferably have a positive dielectric anisotropy and include chiral material in an amount effective to form focal conic and twisted planar textures. Chiral nematic liquid crystal materials are preferred because of their excellent reflective characteristics, bi-stability and gray scale memory. The chiral nematic liquid crystal is typically a mixture of nematic liquid crystal and chiral material in an amount sufficient to produce the desired pitch length. Suitable commercial nematic liquid crystals include, for example, E7, E44, E48, E31, E80, BL087, BL101, ZLI-3308, ZLI-3273, ZLI-5048-000, ZLI-5049-100, ZLI-5100-100, ZLI-5800-000, MLC-6041-100.TL202, TL203, TL204 and TL205 manufactured by E. Merck (Darmstadt, Germany). Although nematic liquid crystals having positive dielectric anisotropy, and especially cyanobiphenyls, are preferred, virtually any nematic liquid crystal known in the art, including those having negative dielectric anisotropy should be suitable for use in the invention. Other nematic materials may also be suitable for use in the present invention as would be appreciated by those skilled in the art.

The chiral dopant added to the nematic mixture to induce the helical twisting of the mesophase, thereby allowing reflection of visible light, can be of any useful structural class. The choice of dopant depends upon several characteristics including among others its chemical compatibility with the nematic host, helical twisting power, temperature sensitivity, and light fastness. Many chiral dopant classes are known in the art: for example, G. Gottarelli and G. Spada, Mol. Cryst. Liq. Crys., 123, 377 (1985); G. Spada and G. Proni, Enantiomer, 3, 301 (1998), U.S. Pat. No. 6,217,792; U.S. Pat. No. 6,099,751; and U.S. patent application Ser. No. 10/651,692, hereby incorporated by reference.

Chiral nematic liquid crystal materials and cells, as well as polymer stabilized chiral nematic liquid crystals and cells, are well known in the art and described in, for example, co-pending application Ser. No. 07/969,093 filed Oct. 30, 1992; Ser. No. 08/057,662 filed May 4, 1993; Yang et al., Appl. Phys. Lett. 60(25) pp 3102-04 (1992); Yang et al., J. Appl. Phys. 76(2) pp 1331 (1994); published International Patent Application No. PCT/US92/09367; and published International Patent Application No. PCT/US92/03504, all of which are incorporated herein by reference.

Carriers

In a preferred embodiment, a light-modulating layer is deposited over a first conductor. The light-modulating layer contains a chiral nematic liquid crystal. The selected material preferably exhibits high optical and electrical anisotropy and matches the index of refraction of the carrier polymer, when the material is electrically oriented. Examples of such materials are E. Merck's BL-03, BL-048 or BL-033, which are available from EM Industries of Hawthorne, N.Y. Other light reflecting or diffusing modulating, electrically operated materials can also be coated, such as a micro-encapsulated electrophoretic material in oil.

The liquid crystal can be a chiral doped nematic liquid crystal, also known as cholesteric liquid crystal, such as those disclosed in U.S. Pat. No. 5,695,682. Application of fields of various intensity and duration change the state of chiral doped nematic materials from a reflective to a transmissive state. These materials have the advantage of maintaining a given state indefinitely after the field is removed. Cholesteric liquid crystal materials can be Merck BL112, BL118 or BL126 that are available from EM Industries of Hawthorne, N.Y. The light-modulating layer is effective in two conditions.

As used herein, the phase a “liquid crystal display” (LCD) is a type of flat panel display used in various electronic devices. At a minimum, an LCD comprises a substrate, at least one conductive layer and a liquid crystal layer. LCDs may also comprise two sheets of polarizing material with a liquid crystal solution between the polarizing sheets. The sheets of polarizing material may comprise a substrate of glass or transparent plastic. The LCD may also include functional layers. In one embodiment of an LCD, a transparent, multilayer flexible support is coated with a first conductive layer, which may be patterned, onto which is coated the light-modulating liquid crystal layer. A second conductive layer is applied and overcoated with a dielectric layer to which dielectric conductive row contacts are attached, including vias that permit interconnection between conductive layers and the dielectric conductive row contacts. An optional nanopigmented functional layer may be applied between the liquid crystal layer and the second conductive layer.

The liquid crystal (LC) is used as an optical switch. The substrates are usually manufactured with transparent, conductive electrodes, in which electrical “driving” signals are coupled. The driving signals induce an electric field which can cause a phase change or state change in the LC material, the LC exhibiting different light-reflecting characteristics according to its phase and/or state.

There are alternative display technologies to LCDs that can be used, for example, in flat panel displays. A notable example is organic or polymer light-emitting devices (OLEDs) or (PLEDs), which are comprised of several layers in which one of the layers is comprised of an organic material that can be made to electroluminesce by applying a voltage across the device. An OLED device is typically a laminate formed in a substrate such as glass or a plastic polymer. A light-emitting layer of a luminescent organic solid, as well as adjacent semiconductor layers, are sandwiched between an anode and a cathode. The semiconductor layers can be whole-injecting and electron-injecting layers. PLEDs can be considered a subspecies of OLEDs in which the luminescent organic material is a polymer. The light-emitting layers may be selected from any of a multitude of light-emitting organic solids, for example, polymers that are suitably fluorescent or chemiluminescent organic compounds. Such compounds and polymers include metal ion salts of 8-hydroxyquinolate, trivalent metal quinolate complexes, trivalent metal bridged quinolate complexes, Schiff-based divalent metal complexes, tin(IV) metal complexes, metal acetylacetonate complexes, metal bidenate ligand complexes incorporating organic ligands, such as 2-picolylketones, 2-quinaldylketones, or 2-(o-phenoxy)pyridine ketones, bisphosphonates, divalent metal maleonitriledithiolate complexes, molecular charge transfer complexes, rare earth mixed chelates, (5-hydroxy)quinoxaline metal complexes, aluminum tris-quinolates, and polymers such as poly(p-phenylenevinylene), poly(dialkoxyphenylenevinylene), poly(thiophene), poly(fluorene), poly(phenylene), poly(phenylacetylene), poly(aniline), poly(3-alkylthiophene), poly(3-octylthiophene), and poly(N-vinylcarbazole). When a potential difference is applied across the cathode and anode, electrons from the electron-injecting layer and holes from the hole-injecting layer are injected into the light-emitting layer; they recombine, emitting light. OLEDs and PLEDs are described in the following U.S. patents, all of which are incorporated herein by this reference: U.S. Pat. No. 5,707,745 to Forrest et al., U.S. Pat. No. 5,721,160 to Forrest et al., U.S. Pat. No. 5,757,026 to Forrest et al., U.S. Pat. No. 5,834,893 to Bulovic et al., U.S. Pat. No. 5,861,219 to Thompson et al., U.S. Pat. No. 5,904,916 to Tang et al., U.S. Pat. No. 5,986,401 to Thompson et al., U.S. Pat. No. 5,998,803 to Forrest et al., U.S. Pat. No. 6,013,538 to Burrows et al., U.S. Pat. No. 6,046,543 to Bulovic et al., U.S. Pat. No. 6,048,573 to Tang et al., U.S. Pat. No. 6,048,630 to Burrows et al., U.S. Pat. No. 6,066,357 to Tang et al., U.S. Pat. No. 6,125,226 to Forrest et al., U.S. Pat. No. 6,137,223 to Hung et al., U.S. Pat. No. 6,242,115 to Thompson et al., and U.S. Pat. No. 6,274,980 to Burrows et al.

In a typical matrix-address light-emitting display device, numerous light-emitting devices are formed on a single substrate and arranged in groups in a regular grid pattern. Activation may be by rows and columns, or in an active matrix with individual cathode and anode paths. OLEDs are often manufactured by first depositing a transparent electrode on the substrate, and patterning the same into electrode portions. The organic layer(s) is then deposited over the transparent electrode. A metallic electrode can be formed over the electrode layers. For example, in U.S. Pat. No. 5,703,436 to Forrest et al., incorporated herein by reference, transparent indium tin oxide (ITO) is used as the whole-injecting electrode, and a Mg—Ag-ITO electrode layer is used for electron injection.

The display contains at least one conductive layer, which typically is comprised of a primary metal oxide. This conductive layer may comprise other metal oxides such as indium oxide, titanium dioxide, cadmium oxide, gallium indium oxide, niobium pentoxide and tin dioxide. See, Int. Publ. No. WO 99/36261 by Polaroid Corporation. In addition to the primary oxide such as ITO, the at least one conductive layer can also comprise a secondary metal oxide such as an oxide of cerium, titanium, zirconium, hafnium and/or tantalum. See, U.S. Pat. No. 5,667,853 to Fukuyoshi et al. (Toppan Printing Co.) Other transparent conductive oxides include, but are not limited to ZnO₂, Zn₂SnO₄, Cd₂SnO₄, Zn₂In₂O₅, MgIn₂O₄, Ga₂O₃—In₂O₃, or TaO₃. The conductive layer may be formed, for example, by a low temperature sputtering technique or by a direct current sputtering technique, such as DC-sputtering or RF-DC sputtering, depending upon the material or materials of the underlying layer. The conductive layer may be a transparent, electrically conductive layer of tin-oxide or indium-tin-oxide (ITO), or polythiophene, with ITO being the preferred material. Typically, the conductive layer is sputtered onto the substrate to a resistance of less than 250 ohms per square. Alternatively, conductive layer may be an opaque electrical conductor formed of metal such as copper, aluminum or nickel. If the conductive layer is an opaque metal, the metal can be a metal oxide to create a light absorbing conductive layer.

Indium tin oxide (ITO) is the preferred conductive material, as it is a cost effective conductor with good environmental stability, up to 90% transmission, and down to 20 ohms per square resistivity. An exemplary preferred ITO layer has a % T greater than or equal to 80% in the visible region of light, that is, from greater than 400 nm to 700 nm, so that the film will be useful for display applications. In a preferred embodiment, the conductive layer comprises a layer of low temperature ITO which is polycrystalline. The ITO layer is preferably 10-120 nm in thickness, or 50-100 nm thick to achieve a resistivity of 20-60 ohms/square on plastic. An exemplary preferred ITO layer is 60-80 nm thick.

The conductive layer is preferably patterned. The conductive layer is preferably patterned into a plurality of electrodes. The patterned electrodes may be used to form a LCD device. In another embodiment, two conductive substrates are positioned facing each other and cholesteric liquid crystals are positioned therebetween to form a device. The patterned ITO conductive layer may have a variety of dimensions. Exemplary dimensions may include line widths of 10 microns, distances between lines, that is, electrode widths, of 200 microns, depth of cut, that is, thickness of ITO conductor, of 100 nanometers. ITO thicknesses on the order of 60, 70, and greater than 100 nanometers are also possible.

The display may also contain a second conductive layer applied to the surface of the light-modulating layer. The second conductive layer desirably has sufficient conductivity to carry a field across the light-modulating layer. The second conductive layer may be formed in a vacuum environment using materials such as aluminum, tin, silver, platinum, carbon, tungsten, molybdenum, or indium. Oxides of these metals can be used to darken patternable conductive layers. The metal material can be excited by energy from resistance heating, cathodic arc, electron beam, sputtering or magnetron excitation. The second conductive layer may comprise coatings of tin-oxide or indium-tin oxide, resulting in the layer being transparent. Alternatively, second conductive layer may be printed conductive ink.

For higher conductivities, the second conductive layer may comprise a silver-based layer which contains silver only or silver containing a different element such as aluminum (Al), copper (Cu), nickel (Ni), cadmium (Cd), gold (Au), zinc (Zn), magnesium (Mg), tin (Sn), indium (In), tantalum (Ta), titanium (Ti), zirconium (Zr), cerium (Ce), silicon (Si), lead (Pb) or palladium (Pd). In a preferred embodiment, the conductive layer comprises at least one of gold, silver and a gold/silver alloy, for example, a layer of silver coated on one or both sides with a thinner layer of gold. See, Int. Publ. No. WO 99/36261 by Polaroid Corporation. In another embodiment, the conductive layer may comprise a layer of silver alloy, for example, a layer of silver coated on one or both sides with a layer of indium cerium oxide (InCeO). See U.S. Pat. No. 5,667,853, incorporated herein in by reference.

The second conductive layer may be patterned irradiating the multilayered conductor/substrate structure with ultraviolet radiation so that portions of the conductive layer are ablated therefrom. It is also known to employ an infra-red (IR) fiber laser for patterning a metallic conductive layer overlying a plastic film, directly ablating the conductive layer by scanning a pattern over the conductor/film structure. See: Int. Publ. No. WO 99/36261 and “42.2: A New Conductor Structure for Plastic LCD Applications Utilizing ‘All Dry’ Digital Laser Patterning,” 1998 SID International Symposium Digest of Technical Papers, Anaheim, Calif., May 17-22, 1998, no. VOL. 29, May 17, 1998, pages 1099-1101, both incorporated herein by reference.

The display may also comprises at least one “functional layer” between the conductive layer and the substrate. The functional layer may comprise a protective layer or a barrier layer. The protective layer useful in the practice of the invention can be applied in any of a number of well known techniques, such as dip coating, rod coating, blade coating, air knife coating, gravure coating and reverse roll coating, extrusion coating, slide coating, curtain coating, and the like. The lubricant particles and the binder are preferably mixed together in a liquid medium to form a coating composition. The liquid medium may be a medium such as water or other aqueous solutions in which the hydrophilic colloid are dispersed with or without the presence of surfactants. A preferred barrier layer may acts as a gas barrier or a moisture barrier and may comprise SiOx, AlOx or ITO. The protective layer, for example, an acrylic hard coat, functions to prevent laser light from penetrating to functional layers between the protective layer and the substrate, thereby protecting both the barrier layer and the substrate. The functional layer may also serve as an adhesion promoter of the conductive layer to the substrate.

In another embodiment, the polymeric support may further comprise an antistatic layer to manage unwanted charge build up on the sheet or web during roll conveyance or sheet finishing. In another embodiment of this invention, the antistatic layer has a surface resistivity of between 10⁵ to 10¹². Above 10¹², the antistatic layer typically does not provide sufficient conduction of charge to prevent charge accumulation to the point of preventing fog in photographic systems or from unwanted point switching in liquid crystal displays. While layers greater than 10⁵ will prevent charge buildup, most antistatic materials are inherently not that conductive and in those materials that are more conductive than 10⁵, there is usually some color associated with them that will reduce the overall transmission properties of the display. The antistatic layer is separate from the highly conductive layer of ITO and provides the best static control when it is on the opposite side of the web substrate from that of the ITO layer. This may include the web substrate itself.

Another type of functional layer may be a color contrast layer. Color contrast layers may be radiation reflective layers or radiation absorbing layers. In some cases, the rearmost substrate of each display may preferably be painted black. The color contrast layer may also be other colors. In another embodiment, the dark layer comprises milled nonconductive pigments. The materials are milled below 1 micron to form “nano-pigments”. In a preferred embodiment, the dark layer absorbs all wavelengths of light across the visible light spectrum, that is from 400 nanometers to 700 nanometers wavelength. The dark layer may also contain a set or multiple pigment dispersions. Suitable pigments used in the color contrast layer may be any colored materials, which are practically insoluble in the medium in which they are incorporated. Suitable pigments include those described in Industrial Organic Pigments: Production, Properties, Applications by W. Herbst and K. Hunger, 1993, Wiley Publishers. These include, but are not limited to, Azo Pigments such as monoazo yellow and orange, diazo, naphthol, naphthol reds, azo lakes, benzimidazolone, diazo condensation, metal complex, isoindolinone and isoindolinic, polycyclic pigments such as phthalocyanine, quinacridone, perylene, perinone, diketopyrrolo-pyrrole, and thioindigo, and anthriquinone pigments such as anthrapyrimidine.

The functional layer may also comprise a dielectric material. A dielectric layer, for purposes of the present invention, is a layer that is not conductive or blocks the flow of electricity. This dielectric material may include a UV curable, thermoplastic, screen printable material, such as Electrodag 25208 dielectric coating from Acheson Corporation. The dielectric material forms a dielectric layer. This layer may include openings to define image areas, which are coincident with the openings. Since the image is viewed through a transparent substrate, the indicia are mirror imaged. The dielectric material may form an adhesive layer to subsequently bond a second electrode to the light modulating layer.

The displays may employ any suitable driving schemes and electronics known to those skilled in the art, including the following, all of which are incorporated herein by reference in their entireties: Doane, J. W., Yang, D. K., Front-lit Flat Panel Display from Polymer Stabilized Cholesteric Textures, Japan Display 92, Hiroshima October 1992; Yang, D. K. and Doane, J. W., Cholesteric Liquid Crystal/Polymer Gel Dispersion: Reflective Display Application, SID Technical Paper Digest, Vol XXIII, May 1992, p. 759, et sea.; U.S. patent application Ser. No. 08/390,068, filed Feb. 17, 1995, entitled “Dynamic Drive Method and Apparatus for a Bistable Liquid Crystal Display” and U.S. Pat. No. 5,453,863.

Liquid crystal domains may be preferably made using a limited coalescence methodology, as disclosed in U.S. Pat. Nos. 6,556,262 and 6,423,368, incorporated herein by reference. Limited coalescence is defined as dispersing a light-modulating material below a given size, and using coalescent limiting material to limit the size of the resulting domains. Such materials are characterized as having a ratio of maximum to minimum domain size of less than 2:1. By use of the term “uniform domains”, it is meant that domains are formed having a domain size variation of less than 2:1. Limited domain materials have improved optical properties.

The display module 10 in FIG. 1, for use with various embodiments of the support, in general consists of a light modulating layer, first and second conductive layers. Referring to FIG. 7, a display 10 according to the present invention includes a display substrate 15, that has a thickness of between 20 and 200 (preferably 125 microns). A first transparent conductor 20 is formed on substrate 15. First transparent conductor 20 can be tin-oxide, indium-tin-oxide (ITO), or polythiophene, with ITO being the preferred material. Typically the material of first transparent conductor 20 is sputtered or coated as a layer over display substrate 15 having a resistance of less than 1000 ohms per square. A second conductive layer 40 may optionally be applied and overcoated with other layers. An optional nanopigmented or color contrast functional layer 35 may be applied between the liquid crystal layer 30 and the second conductive layer 40.

In a preferred embodiment of display module 10, a first conductor cover 22 is printed over first transparent conductor 20. First conductor cover 22 can be screen-printed conductive ink such as Electrodag 423SS screen printable electrical conductive material from Acheson Corporation. Such screen printable conductive materials comprise finely divided graphite particles in a thermoplastic resin. First conductor cover 22 protects first transparent conductor 20 from abrasion.

Light modulating layer 30 overlays a first portion of first transparent conductor 20. A portion of light modulating layer 30 may be removed to create exposed first conductor 20′ to permit electrical contact. Light modulating layer 30 contains cholesteric liquid crystal material, such as those disclosed in U.S. Pat. No. 5,695,682, the disclosure of which is incorporated by reference. Application of electrical fields of various intensity and duration can be employed to drive a chiral nematic material (cholesteric) into a reflective state, to a substantially transparent state, or an intermediate state. These materials have the advantage of having first and second optical states that are both stable in the absence of an electrical field. The materials can maintain a given optical state indefinitely after the field is removed. Cholesteric liquid crystal materials can be Merck BL112, BL118 or BL126, available from E.M. Industries of Hawthorne, N.Y.

In a preferred embodiment, light modulating layer 30 is E.M. Industries' cholesteric material BL-118 dispersed in deionized photographic gelatin. The liquid crystal material is mixed at 8% concentration in a 5% gelatin aqueous solution. The liquid crystal material is dispersed to create an emulsion having 8-10 micron diameter domains of the liquid crystal in aqueous suspension. The domains can be formed using the limited coalescence technique described in U.S. Pat. No. 6,423,368, incorporated herein by reference. The emulsion is coated on a polyester display substrate over the first transparent conductor(s) and dried to provide an approximately 9-micron thick polymer dispersed cholesteric coating. Other organic binders such as polyvinyl alcohol (PVA) or polyethylene oxide (PEO) can be used in place of the gelatin. Such emulsions are machine coatable using coating equipment of the type employed in the manufacture of photographic films. A gel sub layer can be applied over the first transparent conductor 20 prior to applying light modulating layer 30 as disclosed copending U.S. Ser. No. 09/915,441, incorporated herein by reference.

### EXAMPLES

The following examples are provided to illustrate the invention.

### Example 1

The comparative sample A in Table 1 is the prior art with no substrate area 50 (that is, the substrate area 60 covers the whole area of the substrate). Referring to Eqn. (6), the maximum strain, εₘₐₓ, of the layers in the display is equal to

$$\frac{{y}_{max}}{ρ} ,$$

where ρ is the bending radius of curvature and yₘₐₓ is the distance from the center of the beam to the layer of concern. If the maximum strain on display module 10 is required to be less than 1%, we have, εₘₐₓ=1%, and yₘₐₓ=1 mm. Therefore, we have, from Eqn (6), ρ=100 mm, which, is the minimum bending radius of curvature for comparative sample A without rendering the display inoperable. Examples 1 to 4 represent displays of this invention that yield improvement of flexibility. The flexibility is measured in terms of the minimum radius of curvature of the substrate area 50 the display can be bent into without rendering inoperable. As shown in Table 1, the minimum radius of curvature of the display can be reduced by incorporating a substrate area 50 with a high modulus. Comparative sample B fields a higher minimum bending radius of curvature since the Young's modulus of substrate 50 is lower than that of the substrate 60.

TABLE 1

| | Young's | Young's | |
|---|---|---|---|
| | modulus of | modulus of | |
| | low stiffness | high stiffness | Minimum radius of |
| Example 1 | support 60 | support 50 | curvature |
| Comparative | 3.2 GPa | N/A | 100 mm |
| sample A | | | |
| Comparative | 3.2 GPa | 1.6 GPa | 200 mm |
| sample B | | | |
| Example 2 | 3.2 GPa | 6.4 GPa | 50 mm |
| Example 3 | 3.2 GPa | 12.8 GPa | 25 mm |
| Example 4 | 3.2 GPa | 25.6 GPa | 12.5 mm |

### Example 2

For the embodiment shown in FIG. 6, the improvement of flexibility can be shown in terms of the minimum radius of curvature of display in bending without rendering the display inoperable. Note that the pixel area 10 is reinforced by support reinforcement 70 and is therefore stiffer than the between-pixel area. The minimum radius of curvature of the display is defined by the radius of the curvature in the between-pixel area.

Similar to Example 1, the deformation in the display module 10 is required to be less than 1%, which yields a minimum bending radius of curvature for comparative sample B to be 100 mm. For the pixel area in FIG. 6, since there are two material layers, i.e., support 90 and support reinforcement 70, we utilize the approach outlined in “Analysis and Performance of Fiber Composites” (B. D Agarwal and L. J. Broutman, 2nd Edition, John Wiley & Sons, Inc., New York, 1990) for our calculations. We determine the radius of curvature of the between-pixel area when the display module 10 in the pixel area each a critical bending strain of 1%. Such a radius of curvature in the between-pixel area is shown in Table 2 as the minimum radius of curvature. It is easy to see from Table 2 that the improvement on flexibility can be achieved through change of stiffness or thickness.

These two examples clearly show that the flexibility of the display can be improved by proper selection of stiffness and thickness of the embodiments in FIG. 1 and FIG. 6.

TABLE 2

| | | | Support | | | |
|---|---|---|---|---|---|---|
| | Support 90 | | Reinforcement 70 | | Minimum | |
| | Thick- | Young's | Thick- | Young's | radius of | |
| Example 2 | ness | Modulus | ness | Modulus | curvature | |
| Comparative | 2 mm | 3.2 GPa | N/A | N/A | 100 | mm |
| sample C | | | | | | |
| Example 5 | 2 mm | 3.2 GPa | 2 mm | 1.6 GPa | 34.17 | mm |
| Example 6 | 2 mm | 3.2 GPa | 2 mm | 3.2 GPa | 20 | mm |
| Example 7 | 2 mm | 3.2 GPa | 1 mm | 3.2 GPa | 44.8 | mm |
| Example 8 | 2 mm | 3.2 GPa | 3 mm | 32 GPa | 3 | mm |
| Example 9 | 2 mm | 3.2 GPa | 1 mm | 32 GPa | 8.56 | mm |

In some of the display devices considered in this invention, the display modules consists of thin liquid crystal and conductor layers (for example, 10 microns or less LCD, and 0.1 microns ITO conductive layers). These layers have little effect on the bending stiffness of the display substrates. Therefore, the liquid crystal filled cell will experience essentially the same bending curvature as the intermediate part. However, the introduction of a stiffer substrate in the present invention, the bending is concentrated in the between-pixel areas regardless the display enclosure' stiffness. This is very different from what was disclosed in U.S. Pat. No. 6,710,841. According to the description in U.S. Pat. No. 6,710,841, in order to achieve the objective of creating a flexible display, the crystal filled cell enclosures need to be relatively rigid in comparison with the substrates so that bending occurs along the intermediate part rather than through a liquid crystal filled cell.

The invention has been described in detail with particular reference to certain preferred embodiments thereof, but it will be understood that variations and modifications can be effected within the spirit and scope of the invention.

### PARTS LIST

100 Pixel Slot Die Element
110 Flex Slot Die Element
120 Die Manifold
130 Polymer 1 Supply port
140 Pixel Slot Flow Channel
150 Polymer 1 Distribution cavity
160 Polymer 2 Supply port
170 Polymer 2 Distribution cavity
180 Flex Slot Flow Channel
190 Exit Slot
200 Flexible Support Co-extrusion Die
210 Flexible Support Melt Curtain
220 Flexible Support Web
230 Cooling Roller
240 Pixel Flow Chamber Dividing Wall
250 Pixel Flow Chamber Base
260 Flex Slot Flow Channel/Opening
270 Pixel Flow Transition Region
280 Laminate Support Element
290 High Stiffness Pixel Support Region
300 Flex Beam Element
305 Layer 1 Laminate
310 Impression Roller
320 Engraved Roller
330 Coating Trough
340 Scraper Blade
350 Coated Laminate
360 Nip Roller 1
370 Nip Roller 2
380 Layer 2 Stock Roll
390 Layer 2 Laminate
400 Laminated Support

1. A support for an electrically modulated imaging element comprising a flexible substrate of nonhomogeneous material and of uniform thickness, said flexible substrate having a more flexible area and a less flexible area, wherein said less flexible area underlies an electrically modulated imaging area of said electrically modulated imaging element.

2. The support of claim 1 wherein said flexible substrate is uni-directionally flexible.

3. The support of claim 1 wherein said flexible substrate is dual-directionally flexible.

4. The support of claim 1 wherein said more flexible area is at least one strip.

5. The support of claim 1 wherein said less flexible area is a fused area.

6. The support of claim 1 wherein said less flexible area comprises at least one member selected from the group consisting of flexible metal, metal foil, polyethylene terephthalate (PET), polyethylene naphthalate (PEN), polyethersulfone (PES), polycarbonate (PC), polysulfone, phenolic resin, epoxy resin, polyester, polyimide, polyetherester, polyetheramide, and poly(methyl methacrylate).

7. The support of claim 1 wherein said less flexible area comprises fibers, fillers and combinations thereof.

8. The support of claim 1 wherein said more flexible area comprises at least one member selected from the group consisting of cellulose acetate butyrate, aliphatic polyurethanes, polyacrylonitrile, polytetrafluoroethylenes, polyvinylidene fluorides, aliphatic or cyclic polyolefin, polyarylate (PAR), polyetherimide (PEI), polyethersulphone (PES), polyimide (PI), Teflon poly(perfluoro-alboxy)fluoropolymer (PFA), poly(ethylene tetrafluoroethylene)fluoropolymer (PETFE), high density polyethylene (HDPE), low density polyethylene (LDPE), polypropylene and oriented polypropylene (OPP).

9. The support of claim 1 wherein said flexible substrate is a self-supporting substrate.

10. The support of claim 1 wherein the stiffness ratio of said support is from 1.5/1 to 16/1.

11. The support of claim 1 wherein said less flexible area has a radius of curvature from 3 to 10 times that of the more flexible area.

12. The support of claim 1 wherein said the maximum strain on said substrate in said less flexible area is less than 1%.

13. The support of claim 1 wherein the minimum bending radius of curvature of said support is less than 100 mm.

14. The support of claim 1 wherein the minimum bending radius of curvature of said support is less than 50 mm.

15. The support of claim 14 wherein said minimum bending radius of curvature is defined by the radius of the curvature in said more flexible areas.

16. A support comprising a continuous flexible layer having attached thereto at least one reinforcing area, wherein said reinforcing area underlies an electrically modulated imaging area.

17. The support of claim 16 wherein said support is uni-directionally flexible.

18. The support of claim 16 wherein said support is dual-directionally flexible.

19. The support of claim 16 wherein said reinforcing area is at least one strip.

20. The support of claim 16 wherein said reinforcing area is fused to said continuous flexible layer.

21. The support of claim 16 wherein said reinforcing area comprises at least one member selected from the group consisting of flexible metal, metal foil, polyethylene terephthalate (PET), polyethylene naphthalate (PEN), polyethersulfone (PES), polycarbonate (PC), polysulfone, phenolic resin, epoxy resin, polyester, polyimide, polyetherester, polyetheramide, and poly(methyl methacrylate).

22. The support of claim 16 wherein said continuous flexible layer comprises at least one member selected from the group consisting of cellulose acetate butyrate, aliphatic polyurethanes, polyacrylonitrile, polytetrafluoroethylenes, polyvinylidene fluorides, aliphatic or cyclic polyolefin, polyarylate (PAR), polyetherimide (PEI), polyethersulphone (PES), polyimide (PI), Teflon poly(perfluoro-alboxy)fluoropolymer (PFA), poly(ethylene tetrafluoroethylene)fluoropolymer (PETFE), high density polyethylene (HDPE), low density polyethylene (LDPE), polypropylene and oriented polypropylene (OPP).

23. The support of claim 16 wherein said support is a self-supporting substrate.

24. The support of claim 16 wherein the stiffness ratio of said support is from 1.5/1 to 16/1.

25. The support of claim 16 wherein said reinforcing area has a radius of curvature from 3 to 10 times that of the continuous flexible area.

26. The support of claim 16 wherein said the maximum strain on said support in said continuous flexible area is less than 1%.

27. The support of claim 16 wherein the minimum bending radius of curvature of said support is less than 100 mm.

28. The support of claim 16 wherein the minimum bending radius of curvature of said support is less than 50 mm.

29. A display comprising an array of cell enclosures, wherein said cell enclosures comprise an electrically modulated imaging layer, and a first transparent conductive layer applied to a support, wherein said support comprises a flexible substrate of nonhomogeneous material and of uniform thickness having a more flexible area and a less flexible area, wherein said less flexible area underlies said cell enclosure.

30. The display of claim 29 wherein said support is transparent.

31. The display of claim 29 wherein said electrically modulated imaging layer comprises a light modulating material.

32. The display of claim 31 wherein said light modulating material comprises a liquid crystal material.

33. The display of claim 32 wherein said liquid crystal material is a chiral nematic liquid crystal material.

34. The display of claim 29 wherein said electrically modulated imaging layer comprises a polymer dispersed cholesteric liquid crystal layer.

35. The display of claim 34 wherein said polymer is gelatin.

36. The display of claim 29 wherein said conductive layer comprises ITO.

37. The display of claim 29 wherein said conductive layer comprises polythiophene.

38. The display of claim 29 wherein said first transparent conductive layer is a continuous conductive layer.

39. The display of claim 29 wherein said array of cell enclosures is matrix addressable.

40. The display of claim 29 further comprising at least a second electrically conductive layer.

41. A display comprising an array of cell enclosures, wherein said cell enclosures comprise an electrically modulated imaging layer, and a first transparent conductive layer applied to a support, wherein said support comprises a continuous flexible layer having attached thereto at least one reinforcing area, wherein said reinforcing area underlies said cell enclosure.

42. A method for making a flexible substrate of nonhomogeneous material and of uniform thickness comprising:
providing at least a first molten polymer stream and at least a second molten polymer stream;
combining said first molten polymer stream and said second molten polymer stream into a melt curtain, wherein said first molten polymer stream and said second molten polymer stream are adjacent to each other and oriented vertically;
contacting said melt curtain to a cooling roller;
elongating said melt curtain;
cooling said melt curtain on a chill roller; and
stripping said cooled melt curtain off said chill roller.

43. The method of claim 42 wherein said first molten polymer stream is formed from a first polymer and said second molten polymer stream is formed from a second polymer, and wherein said first polymer is less flexible in the non-molten state than said second polymer.

44. The method of claim 42 wherein said elongating utilizes a common draw down ratio of at least 10:1.

45. A coextrusion die apparatus for forming a multi-segment sheet comprising extrusion equipment for supplying at least two molten polymers of differing viscosities connected to a die manifold, wherein said die manifold comprises at least two die blocks, one die block for each of said at least two molten polymers, wherein said die block comprises a polymer inlet port for receiving molten polymer, a polymer distribution cavity connecting said polymer inlet port to a pixel slot flow channel, wherein said pixel slot flow channel is connected to an exit slot, and a substrate for receiving said at least two molten polymers from said exit slot.

46. The coextrusion die apparatus of claim 45 wherein said pixel slot flow channel is 30 mm long with a flow area measuring 1 mm tall by 0.8 mm wide.

47. The coextrusion die apparatus of claim 45 wherein said flex slot flow channel is 6 mm long with a flow area measuring 1 mm tall by 0.2 mm wide.

48. The coextrusion die apparatus of claim 45 wherein said exit slot is 10 mm long with a flow area of 1 mm tall by 20 mm wide.

49. The coextrusion die apparatus of claim 45 wherein said at least two molten polymers are arranged in a repeating pattern with a pitch of 1 mm consisting of one of said at least two polymers at 0.8 mm wide adjacent to the other of said at least two polymers at 0.2 mm.

50. The coextrusion die apparatus of claim 45 wherein said die manifold is structured to provide laminar flow conditions for said at least two polymers.
